(19) United States
(12) Patent Application Publication
(10) Pub. No.: US 2020/0218722 A1
(43) Pub. Date: Jul. 9, 2020

(54) SYSTEM AND METHOD FOR NATURAL LANGUAGE PROCESSING (NLP) BASED SEARCHING AND QUESTION ANSWERING

(71) Applicant: SayMosaic Inc., Palo Alto, CA (US)

(72) Inventors: Gengchen MAI, Santa Barbara, CA (US); Cheng HE, Foster City, CA (US); Sumang LIU, Fremont, CA (US); Ni LAO, Belmont, CA (US)

(21) Appl. No.: 16/240,539

(22) Filed: Jan. 4, 2019

(51) Int. Cl. G06F 16/2452; G06F 16/2455; G06N 20/00

(52) U.S. Cl. CPC G06F 16/24522; G06N 20/00; G06F 16/2455

(57) ABSTRACT

Systems and methods are provided for query responding. An exemplary method implementable by one or more computing devices may comprise: receiving a query, wherein the query includes a first sequence of words; converting the query into a second sequence of words by using a first machine learning model; and obtaining a result for the query by applying a second machine learning model to a combination of the first sequence of words and the second sequence of words.

### FIELD OF THE INVENTION

This disclosure generally relates to natural language processing (NLP), in particular, to methods and devices for NLP based searching and question answering.

### BACKGROUND

Many services that perform information retrieval for Points of Interest (POI) utilize a Lucene-based setup for their semi-structured and unstructured data such as user reviews. While this type of system is easy to implement, it does not make use of semantics, but relies on direct word matches between a query and reviews, leading to a loss in both precision and recall. A semantically enriched information retrieval from semi-structured and unstructured data is needed to support better results for open domain search and question answering.

### SUMMARY

Various embodiments of the present disclosure can include systems, methods, and non-transitory computer readable media configured to respond query. According to one aspect, a method for query responding, implementable by one or more computing devices, may comprise: receiving a query, wherein the query includes a first sequence of words; converting the query into a second sequence of words by using a first machine learning model; and obtaining a result for the query by applying a second machine learning model to a combination of the first sequence of words and the second sequence of words.

In some embodiments, the combination of the program and the query is obtained by concatenating the query and the program. In some embodiments, the method may further comprise: determining if the second sequence of words is within an n-gram space, wherein the n-gram space includes a plurality of n-grams corresponding to sentences, and wherein an n-gram is a sequence of a preset number of words contained in one of the sentences; and if it is determined that the second sequence of words is within the n-gram space, combining the first sequence of words and the second sequence of words by concatenating the first sequence of words and the second sequence of words to obtain a third sequence of words.

In some embodiments, obtaining a result for the query by applying a second sequence to sequence model to a combination of the first sequence of words and the second sequence of words comprises: feeding the third sequence of words into the second machine learning model to obtain a fourth sequence of words; and generating the result for the query based on the fourth sequence of words.

In some embodiments, the method may further comprise: retrieving a plurality of sentences; obtaining a score for each of the plurality of sentences based on a third machine learning model, wherein the score indicates a level of relevance between the query and each sentence; and ranking the plurality of sentences based on their scores. In some embodiments, the result for the query includes the ranked plurality of sentences.

In some embodiments, the first and second machine learning models are sequence to sequence models. In some embodiments, the first and second machine learning models are trained based on training data comprising: a plurality of queries, a plurality of sentences, and a plurality of results, and wherein the plurality of sentences are retrieved from unstructured data. In some embodiments, the second sequence of words includes two words.

According to another aspect, a system for query responding, implementable by one or more computing devices, comprising a processor and a non-transitory computer-readable storage medium storing instructions that, when executed by the processor, cause the system to perform a method, the method comprising: receiving a query, wherein the query includes a first sequence of words; converting the query into a second sequence of words by using a first machine learning model; and obtaining a result for the query by applying a second machine learning model to a combination of the first sequence of words and the second sequence of words.

According to yet another aspect, a non-transitory computer-readable storage medium storing instructions that, when executed by a processor, cause the processor to perform a method for query responding, the method comprising: receiving a query, wherein the query includes a first sequence of words; converting the query into a second sequence of words by using a first machine learning model; and obtaining a result for the query by applying a second machine learning model to a combination of the first sequence of words and the second sequence of words.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an exemplary environment for natural language processing, in accordance with various embodiments.

FIG. 2 illustrates an exemplary system for natural language processing (NLP) based search and question answering, in accordance with various embodiments.

FIG. 3 illustrates exemplary algorithms for natural language processing (NLP) based search and question answering, in accordance with various embodiments.

FIGS. 4A-4B illustrate an exemplary n-gram based learning algorithm for search and question answering and example results, in accordance with various embodiments.

FIG. 5 illustrates a flowchart of an exemplary method for query responding, in accordance with various embodiments.

FIG. 6 illustrates a flowchart of another exemplary method for query responding, in accordance with various embodiments.

FIG. 7 illustrates a flowchart of an exemplary method for model training, in accordance with various embodiments.

FIG. 8 illustrates a block diagram of an exemplary computer system in which any of the embodiments described herein may be implemented.

### DETAILED DESCRIPTION

According to one aspect of the present disclosure, a system and method may collect semi-structured or unstructured data (such as user reviews) from different Points of Interest (POI) of a variety of resources (such as public web pages). The system and method may build one or more NLP models based on a large volume of training data retrieved from the collection of the semi-structured or unstructured data. When the system and method receive a question from a user, they may utilize the one or more trained NLP models to obtain a ranking of pieces of the semi-structured or unstructured data (e.g., user reviews) associated with different POIs which are related to the user's question, where a number of words in each piece of data may be highlighted as an answer of the user's question. Alternatively, the system and method may utilize the one or more trained NLP models to directly generate an answer to the user's question. In some embodiments, the system and method may build a neural machine comprehension model, which, given a question q and a sentence s, may assign a score to the sentence s with respect to whether the sentence s is related to the question q (e.g., whether the sentence s can answer the question q), select phrases from the sentence s which can answer the question q, and predict a corresponding answer for the question q based on the sentence s.

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

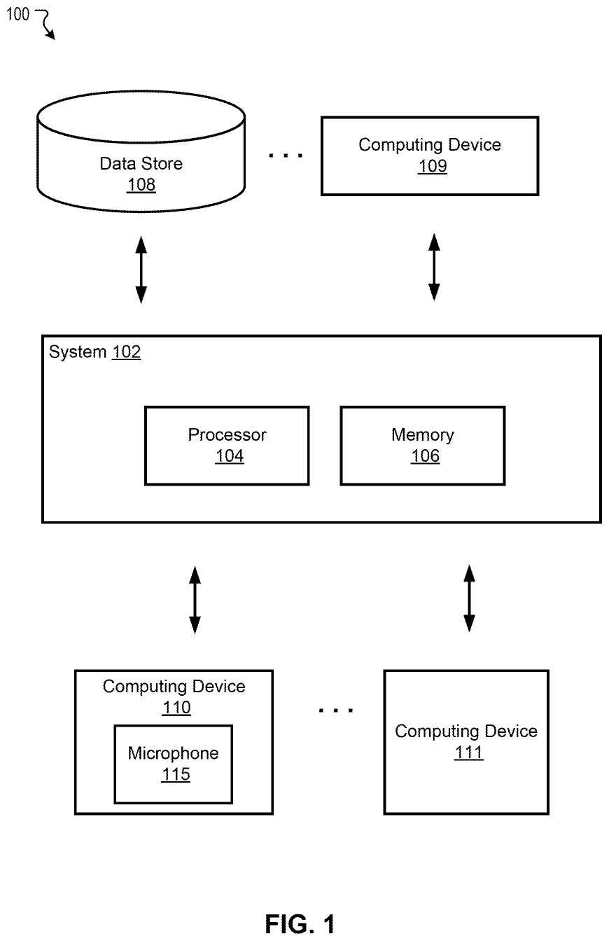

FIG. 1 illustrates an exemplary environment 100 for processing natural language, and performing search and question answering, in accordance with various embodiments. As shown in FIG. 1, the exemplary environment 100 may comprise at least one computing system 102 that includes one or more processors 104 and memory 106. The memory 106 may be non-transitory and computer-readable. The memory 106 may store instructions that, when executed by the one or more processors 104, cause the one or more processors 104 to perform various operations described herein. The instructions may comprise various algorithms, models, and databases described herein. Alternatively, the algorithms, models, and databases may be stored remotely (e.g., on a cloud server) and accessible to the system 102. The system 102 may be implemented on or as various devices such as mobile phone, tablet, server, computer, wearable device (smart watch), etc. The system 102 above may be installed with appropriate software (e.g., platform program, etc.) and/or hardware (e.g., wires, wireless connections, etc.) to access other devices of the environment 100.

The environment 100 may include one or more data stores (e.g., a data store 108) and one or more computing devices (e.g., a computing device 109) that are accessible to the system 102. In some embodiments, the system 102 may be configured to obtain data (e.g., structured, semi-structured and unstructured data) from the data store 108 (e.g., a third-party database) and/or the computing device 109 (e.g., a third-party computer, a third-party server).

The environment 100 may further include one or more computing devices (e.g., computing devices 110 and 111) coupled to the system 102. The computing devices 110 and 111 may comprise devices such as mobile phone, tablet, computer, wearable device (e.g., smart watch, smart headphone), home appliances (e.g., smart fridge, smart speaker, smart alarm, smart door, smart thermostat, smart personal assistant), robot (e.g., floor cleaning robot), etc. The computing devices 110 and 111 may each comprise a microphone or an alternative component configured to capture audio inputs. For example, the computing device 110 may comprise a microphone 115 configured to capture audio inputs. The computing devices 110 and 111 may transmit or receive data to or from the system 102.

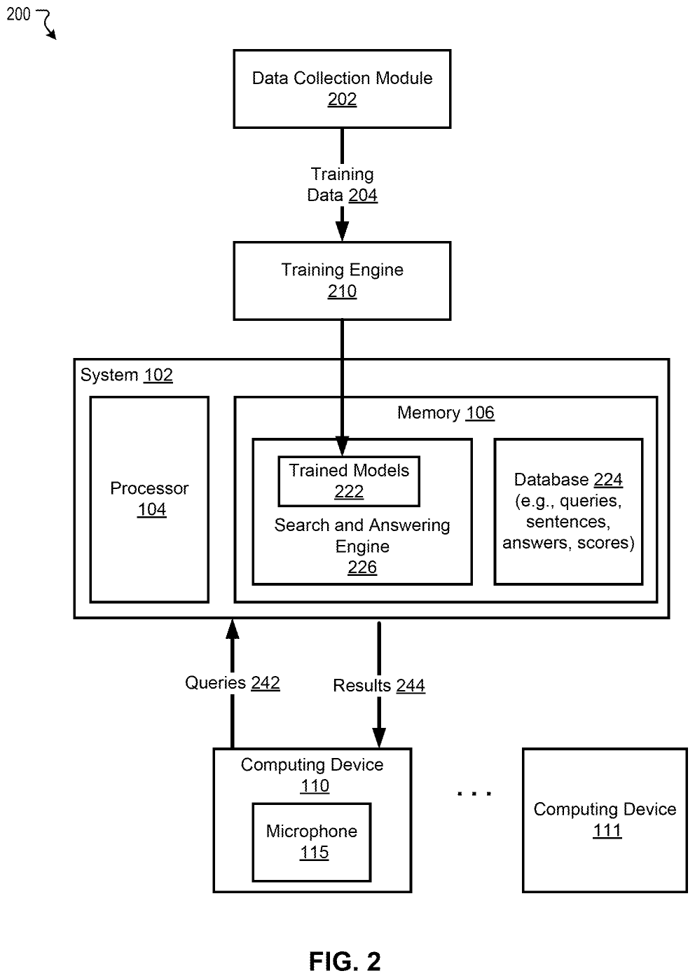

In some embodiments, although the system 102 and the computing device 109 are shown as single components in this figure, it is appreciated that the system 102 and the computing device 109 can be implemented as single devices, multiple devices coupled together, or an integrated device. The data store(s) may be anywhere accessible to the system 102, for example, in the memory 106, in the computing device 109, in another device (e.g., network storage device) coupled to the system 102, or another storage location (e.g., cloud-based storage system, network file system, etc.), etc. The system 102 may be implemented as a single system or multiple systems coupled to each other. In general, the system 102, the computing device 109, the data store 108, and the computing device 110 and 111 may be able to communicate with one another through one or more wired or wireless networks (e.g., the Internet, Bluetooth, radio) through which data can be communicated. Various aspects of the environment 100 are described below in reference to FIG. 2 to FIG. 8.

FIG. 2 illustrates an exemplary system 200 for processing natural language, in accordance with various embodiments. The operations shown in FIG. 2 and presented below are intended to be illustrative. In various embodiments, the system 200 may include a data collection module 202 configured to collect data from a variety of resources and generate training data 204 based on the collected data, and a training engine 210 configured to train NLP models using the training data 204. In the some embodiments, the data collection module 202 and the training engine 210 may reside on the computing device 109, and may be communicative with the system 102 and other entities of the system 200. Trained NLP models may be transmitted, via one or more wired or wireless networks, from the computing device 109 to the system 102 to support search and question answering. In other embodiments, the data collection module 202 and the training engine 210 may be included in the system 102 and support the training of the NLP models in the system 102.

In some embodiments, the data collection module 202 may generate query set based on collected dataset from a variety of resources such as public website data. The data collection module 202 may generate a balanced query set for different business types, e.g., restaurants, coffee shops, bookstores, entertainment places, beauty salons, amusement parks, natural resorts, etc. For example, the data collection module 202 may perform a stratified sampling to collect question and answer dataset. The data collection module 202 may count the frequencies of POI name suffixes (single words) in the collected dataset. For every suffix with at least a preset frequency (e.g., 10 times), the data collection module 202 may create a quoted search query. Such a search query may be restricted to the collected dataset from a pre-determined search domain, e.g., a Question and Answer (Q&A) section of a selected business type (e.g., restaurants) in a public website, etc. The data collection module 202 may collect community Q&A page URLs from one or more public search engines in response to the search query. The data collection module 202 may collect questions and answers from the community Q&A pages.

In some embodiments, for each question, the data collection module 202 may select a preset number of candidate data pieces (e.g., 10 candidate reviews) by stratified sampling from search results of a lucene-based setup, i.e., applying an Elastic search to POI reviews based on the question with constraint to the associated POI types. In some embodiments, the data collection module 202 may also annotate each sentence of these 10 candidate reviews with respect to whether it can answer the current question and what the corresponding answer can be. In some embodiments, the data collection module 202 may also evaluate the question and answer set regarding its accuracy. The training engine 210 may use the annotated question and answer set as the training data 204 to train the NLP models.

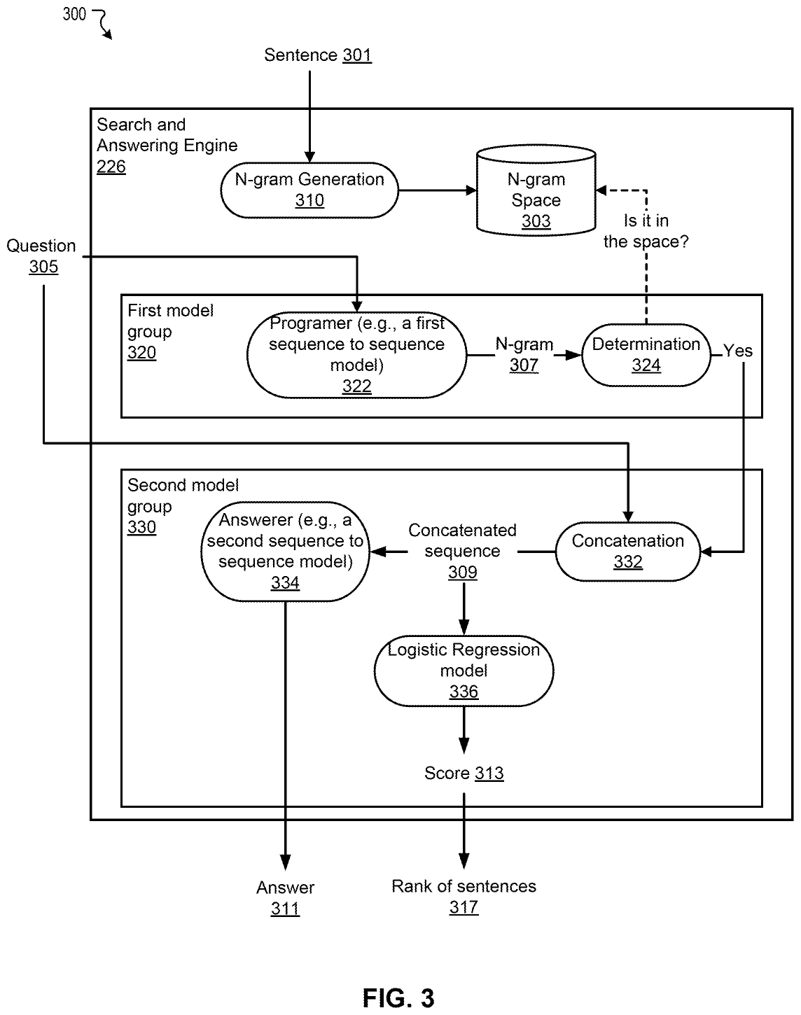

In some embodiments, the system 102 may receive the trained NLP models 222 from the training engine 210. The system 102 may include a search and answering engine 226 in the memory or other components of the system 102. The search and answering engine 226 may incorporate the trained NLP models and may be configured to obtain results 244 in response to receiving queries 242 from the computing device 110. The search and answering engine 226 and the trained NLP models are described below in detail with reference to FIG. 3. The search and answering engine 226 may also communicate with the database 224 to store and retrieve data to and from the database 224. For example, the database 224 may stores queries 242 and results 244 (e.g., answers, sentences from collected data, and/or their scores indicating the relevance to the queries 242, etc.).

FIG. 3 illustrates exemplary algorithms for natural language processing (NLP) based search and question answering, in accordance with various embodiments. The algorithms may be shown in association with an exemplary flowchart 300. The operations shown in FIG. 3 and presented below are intended to be illustrative. Depending on the implementation, the exemplary flowchart 300 may include additional, fewer, or alternative steps performed in various orders or in parallel. Various steps described below which call for “matching” may be performed by algorithms such as rule-based pattern matching.

In some embodiments, the system 102 may feed sentences 301 (e.g., sentences from POI reviews) to the search and answering engine 226 to generate 310 multiple n-grams. An n-gram is a contiguous sequence of “n” items from a given sample of text or speech, where “n” can be any positive integers. For example, an n-gram generated 310 by the search and answering engine 226 may be a contiguous sequence of “n” words in a sentence 301. In some embodiments, the search and answering engine 226 may generate 310 all possible n-grams from each sentence 301 to form an n-gram space 303. For example, the search and answering engine 226 may generate 310 all possible bigrams (e.g., contiguous sequences of two words) from each sentence 301 to form a bigram space 303. With respect to a sentence 301 (e.g., “we were there for about two hours”), the search and answering engine 226 may generate 310 bigrams such as “we were,” “were there,” “there for,” “for about,” “about two,” “two hours,” etc. The bigram space 303 may include all the bigrams generated from the sentence 301. Other types of n-grams may be generated and used to obtain the n-gram space 303, e.g., unigram, trigram, etc.

In some embodiments, the system 102 may feed questions 305 or queries to the first algorithm group 320 and the second algorithm group 330 to obtain answers 311 or rank of sentences 317 as results 244 to the questions 305 or queries. The questions 305 or queries are natural language, such as “how are you today?” “what are their most popular drinks?” “are there any good vegan choices?” etc. The system 102 may first feed the questions 305 to a programmer 322. A programmer 322 may be a machine learning model, which is a set of code or instructions, trained based on training data and executable by one or more processors to perform predetermined functions. For example, the programmer 322 may be a first sequence to sequence machine learning model 322 executable by one or more processors to covert a sequence to another sequence. A sequence may be a series of numbers or characters. In some embodiments, a programmer 322 may be in hardware form or in a mixed form of hardware and software. The programmer 322 may also be configured to perform the functions described below. The first sequence to sequence machine learning model 322, such as the programmer 322, may convert one sequence of words to another sequence of words with the same or a different length (i.e., the number of words). By deriving the relations from the previous words in the same sequence, the sequence to sequence model may be trained to pick a current word with the highest probability from a large pool of words. The sequence to sequence machine learning model 322 may be one of a Long short-term Memory (LSTM) network, a Recurrent Neural network (RNN), a Gated Recurrent Unit (GRU) network, etc. In some embodiments, The programmer 322 may be trained to convert a question 305 (e.g., a sequence of words) to an n-gram 307 such as a bigram (e.g., a contiguous sequence of two words). In the above example where the question 305 is “are there any good vegan choices?”, the programmer 322 may be trained to convert the question 305 to a sequence of words, e.g., “tofu wings.” Each of the words, e.g., “tofu,” “wings,” may correspond to the highest probability among a large word pool, and the word “wings” may be determined upon the determination of “tofu,” which means the relationship between previous word “tofu” and the latter word “wings” may be factored into determining the latter word “wings.”

In some embodiments, the programmer 322 may be trained based on a large amount of annotated question and answer datasets to obtain an n-gram in response to receiving a question or query. However, the challenge is that the training data provides no ground truth n-gram such as bigram. Therefore, the programmer 322 may be trained to select the best bigram (e.g., with the highest probability) from sentences without the ground truth bigram using weak supervision and reinforcement learning. In the weak supervision and reinforcement learning, software agents take actions in an environment so as to maximize some notion of cumulative reward. For example, a trajectory of the programmer 322 may be a sequence of tokens (e.g., words); an action of the programmer 322 may be to select the next token (e.g., word); and a reward to be maximized by the programmer 322 may be that given a generated trajectory (e.g., a sequence of words), how well the generated trajectory helps to answer the question (e.g., measured by Log-likelihood of the Expected Answer from an answerer 334). The answerer 334 will be described in detailed below with reference to the second algorithm group 330.

For example, the training objective function of programmer 322 may be described by the following equation:

$$\begin{matrix}O ( θ ) = {O}^{Q A} ( {θ}_{p τog} , {θ}_{a n s} ) & ( 1 ) \\ = {\sum }_{( {q}_{i} {s}_{i} , {a}_{i} ) ∈ I} {\sum }_{{p}_{k} ∈ K {G}_{i}} [ \frac{β}{\vert K {G}_{i} \vert} + ( 1 - β ) P ( {p}_{k} \vert {q}_{i} , {s}_{i} ; {θ}_{prog} ) ] log P ( {a}_{i} \vert {p}_{k} , {q}_{i} ; {θ}_{a n s} ) & ( 2 )\end{matrix}$$

where, θ_{prog} and θₐₙₛ are the parameter for programmer 322 encoder and answer encoder; I is the training data set; (qᵢ, sᵢ, aᵢ) is one training sample including a question qᵢ, a sentence sᵢ, and an answer aᵢ; KGᵢ is the knowledge graph (also referred to bigram space 303) generated from a sentence sᵢ, which contains all the bigrams of the sentence sᵢ; pₖ is an n-gram from the n-gram space or knowledge graph KGᵢ; and β∈(0, 1) is a hyperparameter which will assign a weight for the sample generated from augmented program pₖ.

In some embodiments, the first algorithm group 320 may determine 324 whether the n-gram 307 outputted from the programmer 322 is within the n-gram space 303 of the sentences 301. If the n-gram 307 is out of the n-gram space 303 of the sentences 301, a meaningful answer or result may not be obtained for the question 305. If the first algorithm group 320 determines 324 that the n-gram 307 is within the n-gram space 303 of the sentences 301, then the first algorithm group 320 may output the n-gram 307 to the second algorithm group 330 for further processing.

The second algorithm group 330 may be configured to receive the n-gram 307 and combine the question 305 and the n-gram 307. In some embodiments, the second algorithm group 330 may concatenate the question 305 with the n-gram 307 to obtain a concatenated sequence 309. For example, if the question 305 is “any good vegan choice?” and the bigram 307 outputted by the programmer 322 is “tofu wings,” then the concatenated sequence 309 may be “any good vegan choice? tofu wings.” In a computer language, the concatenated sequence 309 may be represented by [“any”, “good”, “vegan”, “choices”, “?”, “<QSSEP>”, “tofu”, “wings”]. The second algorithm group 330 may feed the concatenated sequence 309 into an answerer 334. Similar to the programmer 322, an answerer 334 may also be a machine learning model, which is a set of code or instructions, trained based on training data and executable by one or more processors to perform predetermined functions. For example, the answerer 334 may be a second sequence to sequence model. In some embodiments, an answerer 334 may be in hardware form or in a mixed form of hardware and software. The answerer 334 may also be configured to perform the functions described below. For example, the answerer 334 may be trained to generate an answer to the question 305 if the n-gram 307 can answer the question 305 (which may also means that one or more sentences 301 tied to the n-gram 307 such as those sentences 301 including the n-gram 307 can be related to or answer the question 305). The answerer 334 may return no answer to the question 305 if the n-gram 307 cannot answer the question 305 (which means that no collected sentence 301 is able to answer the question 305). In the above example where the question 305 is “any good vegan choice?”, if the bigram 307 is “scan menu,” then the concatenated sequence 309 may be “any good vegan choice? scan menu.” Therefore, the answerer 334 may be trained to output “no answer” to the question 305.

In some embodiments, the answerer 334 may be trained alone based on randomly sampled n-grams from sentences and to be able to generate the answer given a concatenation of a question and an n-gram. The answerer 334 may be one of a Long short-term Memory (LSTM) network, a Recurrent Neural network (RNN), a Gated Recurrent Unit (GRU) network, etc. The answerer 334 alone may improve a search result for a query by only using bigrams sampled from sentences.

In some embodiments, the second algorithm group 330 may also assign a score 313 to a pair of a question and a sentence. For example, for a given question, a different score 313 may be assigned to each pair including the question and a different sentence. The score 313 may indicate a relevance between the question and the sentence. For example, the score 313 may indicate whether the sentence can answer the question. If the sentence can answer the question, then a score 313 of “1” may be assigned to the sentence and question pair. Otherwise, if the sentence is irrelevant or cannot answer the question, then a score 313 of “0” may be assigned to the sentence and question pair. In some embodiments, the score 313 may indicate how well the sentence answers the question. For example, a score 313 in the range of 0-1 (e.g., 0.1, 0.5, 0.9) may be assigned to the pair of sentence and question based on how well the sentence may answer the question or how relevant to the question the sentence may be.

In some embodiments, a machine learning model 336 may be trained based on labeled training data to output a score 313 (e.g., in the range of 0-1) when receiving a pair of question and sentence. For example, the machine learning model may be a logistic regression model 336. Other types of machine learning models can also be used to generate a score 313 for a pair of question 305 and sentence 301. The training data may include pairs of sentences and questions as well as scores assigned to the pairs. The scores may be 0 or 1. In some embodiments, as shown in FIG. 3, the search and answering engine 226 receives a sentence 301 and a question 305. After the foregoing operations described with reference to the modules 310, 322, 324, 332, a concatenated sequence 309 is obtained based on the sentence 301 and the question 305. The sentence 301 corresponds to the n-gram 307 used to obtain the concatenated sequence 309. Thus, by feeding the concatenated sequence 309 to the machine learning model 336, a score 313 for the pair of the question 305 and the sentence 301 may be obtained. In some embodiments, the scores 313 obtained through the logistic regression model 336 may be used to rank sentences 301. For example, as a result for a query, the sentences 301 may be provided in an order of the scores from high to low.

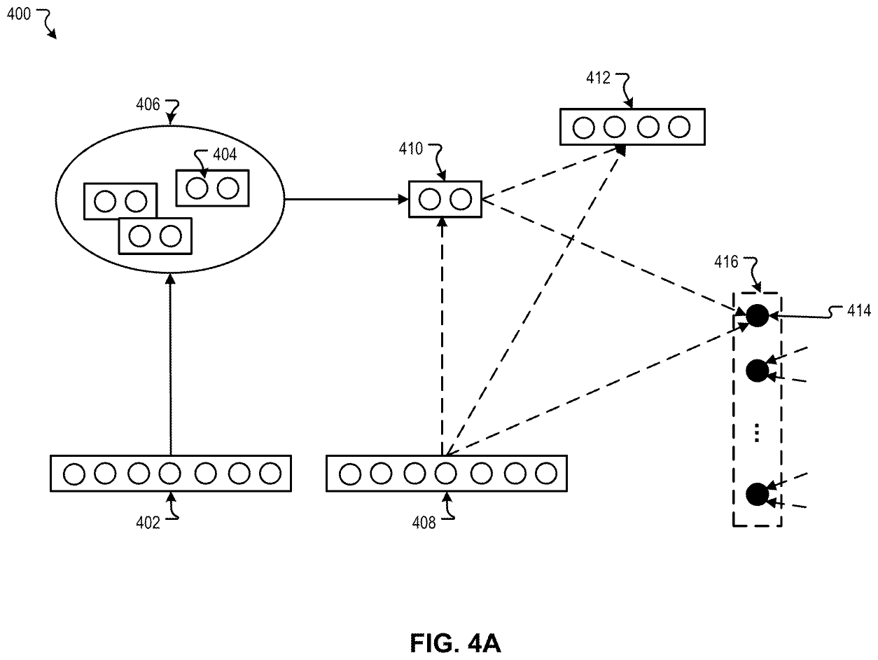

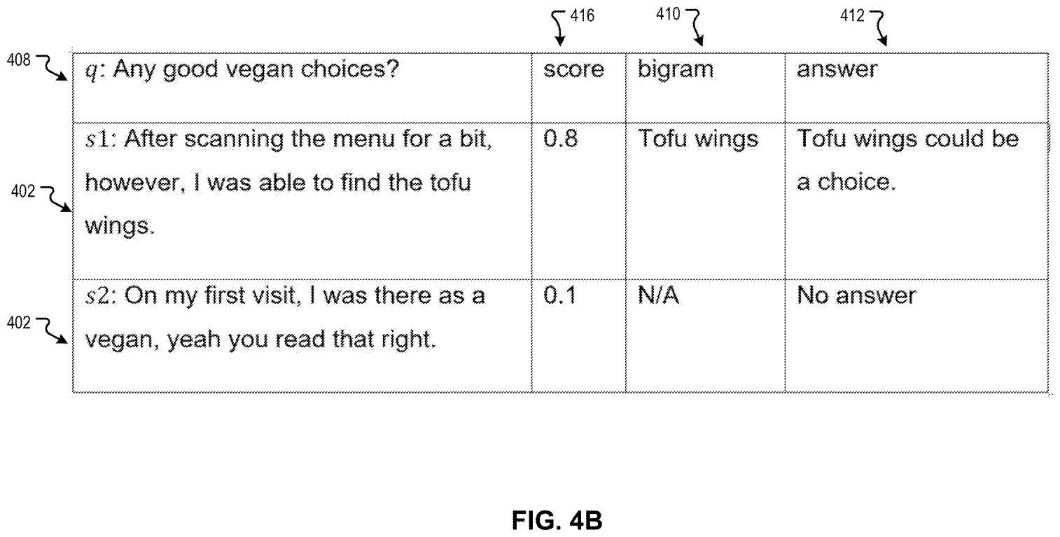

Referring to FIGS. 4A-4B, an exemplary n-gram based learning algorithm for search and question answering and example results are illustrated in accordance with various embodiments. The exemplary algorithm may be shown in association with an exemplary flow diagram 400. The operations and results shown in FIGS. 4A-4B and presented below are intended to be illustrative. Depending on the implementation, the operations may include additional, fewer, or alternative steps performed in various orders or in parallel. The results may also include additional, fewer, or alternative data.

In FIG. 4A, graph 402 represents a sentence (e.g., the sentence 301). As shown in FIG. 4B, a first sentence 402 may be “After scanning the menu for a bit however, I was able to find the tofu wings.” A second sentence 402 may be “On my first visit, I was there as a vegan, yeah you read that right.” In FIG. 4A, circle 406 represents an n-gram space or knowledge graph (e.g., the n-gram space 303) obtained from multiple sentences 402. In the n-gram space 406, there may be a number of n-grams, which are graphically represented by blocks 404. These n-grams 404 have been generated from the one or more sentences 402. Graph 408 represents a question (e.g., the question 305) inputted by a user. As shown in FIG. 4B, for example, the question 408 may be “Any good vegan choices?”

Referring back to FIG. 4A, through a sequence to sequence model (e.g., the first sequence to sequence model 322), an n-gram 410 may be obtained given the question 408. For example, the n-gram 410 may correspond to the highest log-likelihood. The first sequence to sequence model 322 may also check whether the n-gram 410 is within the n-gram space 406. As shown in FIG. 4B, the n-gram 410 may be a bigram, e.g., “Tofu wings.” This bigram 410 “Tofu wings” may be obtained from the first sentence 402—“After scanning the menu for a bit however, I was able to find the tofu wings,” and correspond to the highest log-likelihood. In the embodiments shown in FIG. 4B, the second exemplary sentence—“On my first visit, I was there as a vegan, yeah you read that right”—may also be used to generate multiple bigrams. However, none of the bigrams generated from the second sentence correspond to the highest log-likelihood based on the first sequence to sequence model 322, and thus may not be selected by the model 322.

In some embodiments, based on the question 408 and the n-gram 410, an answer 412 may be generated based on a second sequence to sequence model 334 as described with reference to FIG. 3. As shown in FIG. 4B, the answer 412 may be “Tofu wings could be a choice.” In contrast, since no n-gram has been chosen from the second sentence, the second sentence then may not be able to yield an answer. Referring back to FIG. 4A, a score 416 may also be obtained based on the question 408 and the n-gram 410, indicating the relevance between the sentence 402 and the question 408. For example, as shown in FIG. 4B, the pair of the question 408 and the first sentence may have a score of “0.8,” indicating the first sentence answers the question 408 well, while the pair of the question 408 and the second sentence may have a score of “0.1,” indicating the second sentence may not be able to answer the question 408. Referring back to FIG. 4A, the scores 416 associated with sentences 402 may be used as one of the criteria to rank the sentences 402. As shown in FIG. 4B, the first sentence may have a higher rank than the second sentence.

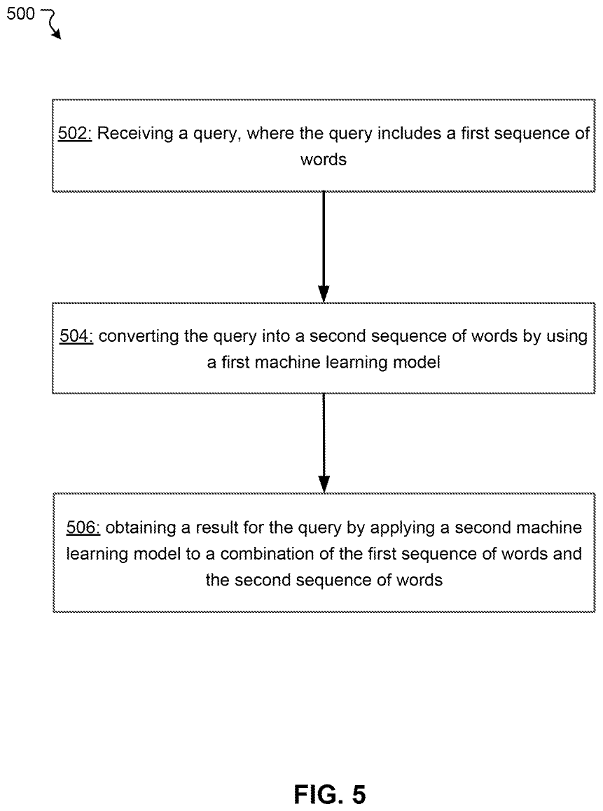

FIG. 5 illustrates a flowchart of an exemplary method for query responding, in accordance with various embodiments. The method 500 may be implemented in various environments including, for example, the environment 100 of FIG. 1, or the exemplary system 200 of FIG. 2. The exemplary method 500 may be implemented by one or more components of the system 102 (e.g., the processor 104, the memory 106). The exemplary method 500 may be implemented by multiple systems similar to the system 102. The operations of method 500 presented below are intended to be illustrative. Depending on the implementation, the exemplary method 500 may include additional, fewer, or alternative steps performed in various orders or in parallel.

At block 502, a query may be received, where the query may include a first sequence of words. For example, the query may be “Are there classes for seniors?” At block 504, the query may be converted into a second sequence of words by using a first machine learning model. In the above example, the query may be converted to a bigram, e.g., “for all.” The first machine learning model may be a sequence to sequence model trained based on annotated question answer dataset to find the most relevant data for the query. At block 506, a result for the query may be obtained by applying a second machine learning model to a combination of the first sequence of words and the second sequence of words. For example, the query and the bigram may be concatenated and sent to a second sequence to sequence model to obtain a result for the query. The result may be an answer for the query. The result may also be a sentence from the dataset and corresponded by the bigram.

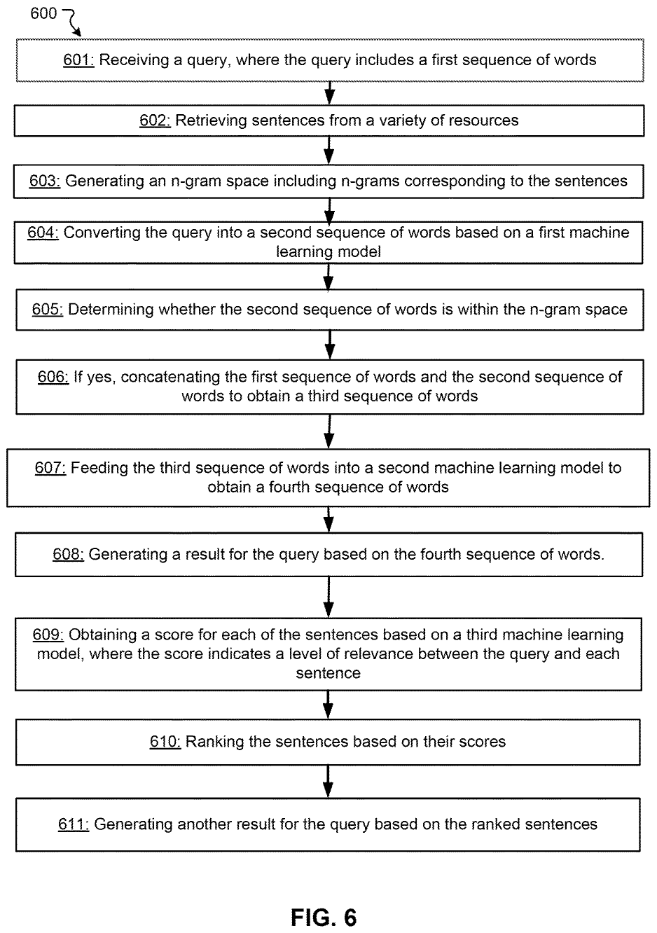

FIG. 6 illustrates a flowchart of another exemplary method for query responding, in accordance with various embodiments. The method 600 may be implemented in various environments including, for example, the environment 100 of FIG. 1, or the exemplary system 200 of FIG. 2. The exemplary method 600 may be implemented by one or more components of the system 102 (e.g., the processor 104, the memory 106). The exemplary method 600 may be implemented by multiple systems similar to the system 102. The operations of method 600 presented below are intended to be illustrative. Depending on the implementation, the exemplary method 600 may include additional, fewer, or alternative steps performed in various orders or in parallel.

At block 601, a query may be received, where the query includes a first sequence of words. At block 602, sentences may be retrieved from a variety of resources. At block 603, an n-gram space may be generated and the n-gram space may include a large number of n-grams corresponding to the retrieved sentences. At block 604, the query may be converted into a second sequence of words based on a first machine learning model (e.g., a first sequence to sequence model). The second sequence of words may be an n-gram such as a bigram. At block 605, it may be determined whether the second sequence of words is within the n-gram space. At block 606, if it is determined that the second sequence of words is within the n-gram space, the first sequence of words may be concatenated with the second sequence of words to obtain a third sequence of words.

At block 607, the third sequence of words may be fed into a second machine learning model to obtain a fourth sequence of words. For example, the fourth sequence of words is an answer to the received query at block 601. At block 608, a result for the query may be generated based on the fourth sequence of words. For example, a reply to the query may be generated based on the answer. At block 609, a score for each of the sentences may be obtained based on a third machine learning model (e.g., a logistic regression model), where the score indicates a level of relevance between the query and the each sentence. At block 610, the sentences may be ranked based on their scores. For example, the sentence with the highest score (e.g., the most relevant sentence) may be ranked the first. The following sentences are in the order of the score from high to low. At block 611, another result (other than the result at block 608) may be generated for the query based on the ranked sentences. For example, this result may be a list of sentences from the most relevant to the least relevant.

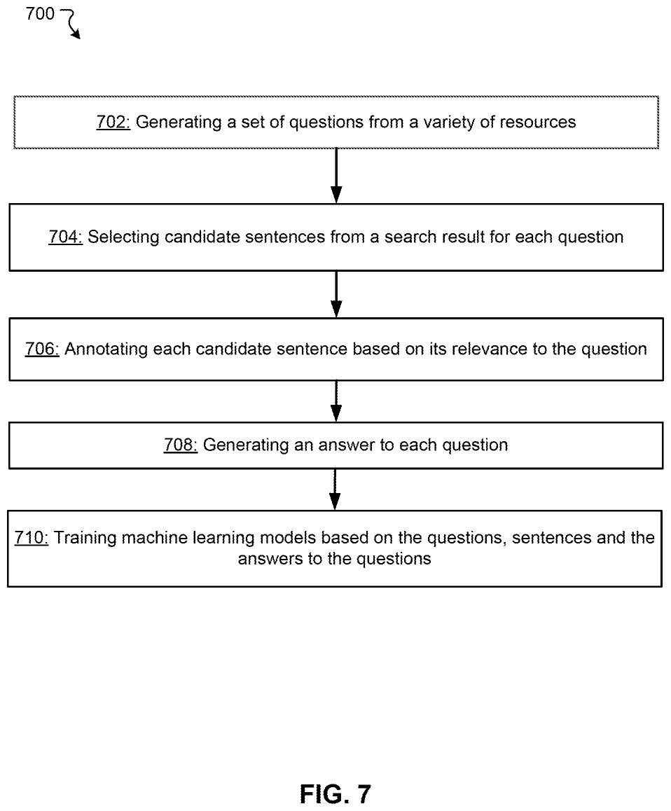

FIG. 7 illustrates a flowchart of an exemplary method for model training, in accordance with various embodiments. The method 700 may be implemented in various environments including, for example, the environment 100 of FIG. 1, or the exemplary system 200 of FIG. 2. The exemplary method 700 may be implemented by one or more components of the system 102 (e.g., the processor 104, the memory 106). The exemplary method 700 may be implemented by multiple systems similar to the system 102. The operations of method 700 presented below are intended to be illustrative. Depending on the implementation, the exemplary method 700 may include additional, fewer, or alternative steps performed in various orders or in parallel.

At block 702, a set of questions may be generated from a variety of resources. For example, a large number of questions may be collected from a variety of public web pages. In some embodiments, each question may be associated with one or more POIs with a number of POI types, e.g., ABC Bar (Cocktail Bars, Lounges), DEF Club (Music Venues, Bars, Dance Clubs), etc. At block 704, candidate sentences may be selected from a search result for each question. For example, an Elastic search may be applied to POI reviews based on the question with constraint to the associated POI types (e.g., Cocktail Bars, Lounges, Music Venues, Bars, Dance Clubs, etc.). At block 706, each candidate sentence may be annotated based on its relevance to the question. Thus, for a question, candidate sentences may be annotated with respect to whether it can answer the question. At block 708, an answer may be generated to each question. For example, a corresponding answer may also be attached to the question. At block 710, machine learning models may be trained based on the questions, sentences and the answers to the questions.

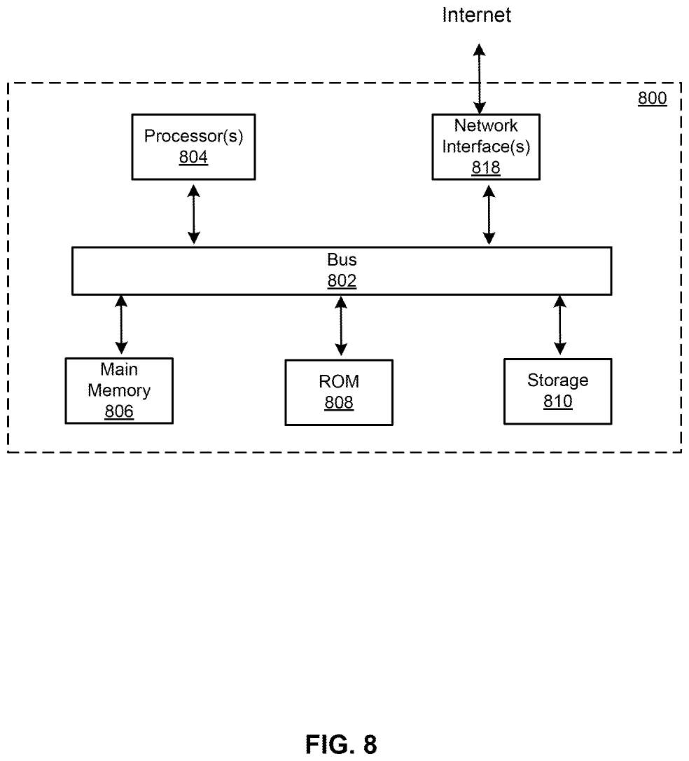

FIG. 8 is a block diagram that illustrates a computer system 800 upon which any of the embodiments described herein may be implemented. The system 800 may correspond to the environment 100 or the system 102 described above. The computer system 800 includes a bus 802 or other communication mechanism for communicating information, one or more hardware processors 804 coupled with bus 802 for processing information. Hardware processor(s) 804 may be, for example, one or more general purpose microprocessors. The processor(s) 804 may correspond to the processor 104 described above.

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions. The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions. The main memory 806, the ROM 808, and/or the storage 810 may correspond to the memory 106 described above.

The computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative embodiments, hard-wired circuitry may be used in place of or in combination with software instructions.

The main memory 806, the ROM 808, and/or the storage 810 may include non-transitory storage media. The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 800 also includes a communication interface 818 coupled to bus 802. Communication interface 818 provides a two-way data communication coupling to one or more network links that are connected to one or more local networks. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN (or WAN component to communicated with a WAN). Wireless links may also be implemented. In any such implementation, communication interface 818 sends and receives electrical, electromagnetic or optical signals that carry digital data streams representing various types of information.

The computer system 800 can send messages and receive data, including program code, through the network(s), network link and communication interface 818. In the Internet example, a server might transmit a requested code for an application program through the Internet, the ISP, the local network and the communication interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm or model. In some embodiments, a machine learning algorithm or model may not explicitly program computers to perform a function, but can learn from training data to make a predictions model (a trained machine learning model) that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. A method for query responding, implementable by one or more computing devices, the method comprising:
receiving a query, wherein the query includes a first sequence of words;
converting the query into a second sequence of words by using a first machine learning model; and
obtaining a result for the query by applying a second machine learning model to a combination of the first sequence of words and the second sequence of words.

2. The method of claim 1, wherein the combination of the program and the query is obtained by concatenating the query and the program.

3. The method of claim 1, further comprising:
determining if the second sequence of words is within an n-gram space, wherein the n-gram space includes a plurality of n-grams corresponding to sentences, and wherein an n-gram is a sequence of a preset number of words contained in one of the sentences; and
if it is determined that the second sequence of words is within the n-gram space, combining the first sequence of words and the second sequence of words by concatenating the first sequence of words and the second sequence of words to obtain a third sequence of words.

4. The method of claim 3, wherein obtaining a result for the query by applying a second sequence to sequence model to a combination of the first sequence of words and the second sequence of words comprises:
feeding the third sequence of words into the second machine learning model to obtain a fourth sequence of words; and
generating the result for the query based on the fourth sequence of words.

5. The method of claim 1, further comprising:
retrieving a plurality of sentences;
obtaining a score for each of the plurality of sentences based on a third machine learning model, wherein the score indicates a level of relevance between the query and each sentence; and
ranking the plurality of sentences based on their scores.

6. The method of claim 5, wherein the result for the query includes the ranked plurality of sentences.

7. The method of claim 1, wherein the first and second machine learning models are sequence to sequence models.

8. The method of claim 1, wherein the first and second machine learning models are trained based on training data comprising: a plurality of queries, a plurality of sentences, and a plurality of results, and wherein the plurality of sentences are retrieved from unstructured data.

9. The method of claim 1, wherein the second sequence of words includes two words.

10. A system for query responding, implementable by one or more computing devices, comprising a processor and a non-transitory computer-readable storage medium storing instructions that, when executed by the processor, cause the system to perform a method, the method comprising:
receiving a query, wherein the query includes a first sequence of words;
converting the query into a second sequence of words by using a first machine learning model; and
obtaining a result for the query by applying a second machine learning model to a combination of the first sequence of words and the second sequence of words.

11. The system of claim 10, wherein the combination of the program and the query is obtained by concatenating the query and the program.

12. The system of claim 10, wherein the method further comprises:
determining if the second sequence of words is within an n-gram space, wherein the n-gram space includes a plurality of n-grams corresponding to sentences, and wherein an n-gram is a sequence of a preset number of words contained in one of the sentences; and
if it is determined that the second sequence of words is within the n-gram space, combining the first sequence of words and the second sequence of words by concatenating the first sequence of words and the second sequence of words to obtain a third sequence of words.

13. The system of claim 12, wherein obtaining a result for the query by applying a second sequence to sequence model to a combination of the first sequence of words and the second sequence of words comprises:
feeding the third sequence of words into the second machine learning model to obtain a fourth sequence of words; and
generating the result for the query based on the fourth sequence of words.

14. The system of claim 10, wherein the method further comprises:
retrieving a plurality of sentences;
obtaining a score for each of the plurality of sentences based on a third machine learning model, wherein the score indicates a level of relevance between the query and each sentence; and
ranking the plurality of sentences based on their scores.

15. The system of claim 14, wherein the result for the query includes the ranked plurality of sentences.

16. The system of claim 10, wherein the first and second machine learning models are sequence to sequence models.

17. The system of claim 10, wherein the first and second machine learning models are trained based on training data comprising: a plurality of queries, a plurality of sentences, and a plurality of results, and wherein the plurality of sentences are retrieved from unstructured data.

18. The system of claim 10, wherein the second sequence of words includes two words.

19. A non-transitory computer-readable storage medium storing instructions that, when executed by a processor, cause the processor to perform a method for query responding, the method comprising:
receiving a query, wherein the query includes a first sequence of words;
converting the query into a second sequence of words by using a first machine learning model; and
obtaining a result for the query by applying a second machine learning model to a combination of the first sequence of words and the second sequence of words.

20. The non-transitory computer-readable storage medium in claim 19, wherein the combination of the program and the query is obtained by concatenating the query and the program.
